(19) United States
(12) Patent Application Publication
(10) Pub. No.: US 2019/0005427 A1
(43) Pub. Date: Jan. 3, 2019

(54) PROFIT GENERATION METHOD BY MEANS OF BUILDING TEAM UTILIZING IDLE RESOURCES ASSOCIATED WITH OCCURRENCE OF SCRAPS

(71) Applicants: TAE HO LEE, Seoul (KR); JOALOGIS CO., LTD., Pyeongtaek-si, Gyeonggi-do (KR)

(72) Inventor: Tae Ho LEE, Seoul (KR)

(21) Appl. No.: 15/735,892

(22) PCT Filed: Jun. 17, 2016
(86) PCT No.: PCT/KR2016/006490

§ 371 Date: Dec. 12, 2017

(30) Foreign Application Priority Data
Jun. 18, 2015 (KR) 10-2015-0086924

(51) Int. Cl. G06Q 10/06; G06Q 50/04

(52) U.S. Cl. CPC G06Q 10/06313; G06Q 50/04

(57) ABSTRACT

The present invention relates to a scrap metal supply method using idle resources, the method combining the idle resources which are of many types, scattered in many places and owned by different owners, such that a series of steps for supplying scrap metal generated in a demolition site to a steel manufacturer can be performed.

### TECHNICAL FIELD

The present invention relates to a scrap metal supply method using idle resources, the method combining the idle resources which are of many types, scattered in many places and owned by different owners, such that a series of steps for supplying scrap metal generated in a demolition site to a steel manufacturer can be performed.

### BACKGROUND

As generally known in the art, a resource and energy used to manufacture iron materials may be reduced to protect an environment by classifying and collecting various types of scrap metals having various materials and various shapes such as judicial materials occurring from various production activities, discarded molds used in various production activities, reinforced materials generated from dismantled buildings, metal wastes including scrap vehicles, waste gas cylinders or metal cans exhausted from consumption activities to melt them in a blast furnace.

To this end, scrap metals of various shapes and various materials are classified according to materials thereof through a basic classification so that a compressed scrap metal is molded to have a shape and a size that can be charged directly to the furnace in a steel manufacturer being the demand. The compressed scrap metals should have a horizontal distance, a vertical distance, and a height in the range of 600 mm to 2,100 mm and a density greater than 0.15.

In order to manufacture the compressed scrap metal according to the related art, iron scraps or non-iron material such as aluminum, copper collected through a variety of routes are classified and the classified scrap metals are provided into a compressor, which is formed into cubes having a compression size so that a compressed scrap metal is molded.

Examples of resources used essentially in a series of processes for supplying scrap metals to a steel manufacturer when the metal scarps occur are as follows.

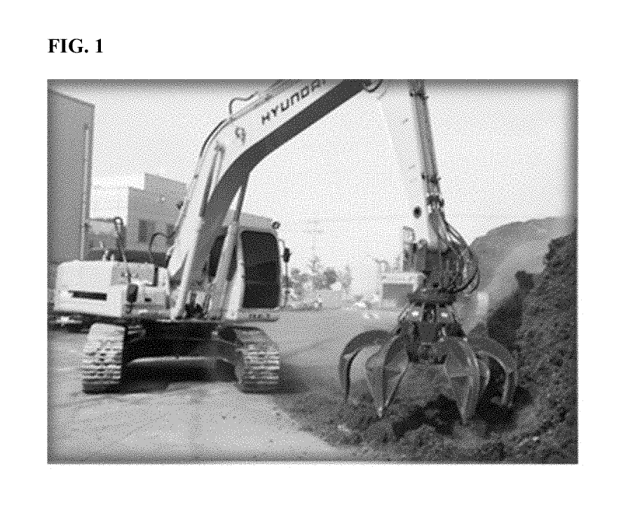

A first resource is an excavator. The excavator uses various mounting devices such as a crusher being a cutter having various scissors shapes for field processing and a grip bucket being a working device for moving (see FIG. 1: (Ltd.) Yonil GNS internet site [http://www.yonil.co.kr] 2015 Jun. 9)

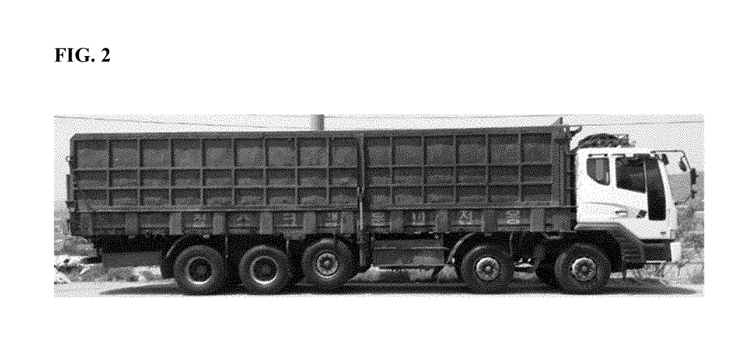

A second resource is a cargo truck. The cargo truck is a vehicle to stably transport scrap metals by mounting a scrap metal in a cargo vehicle. (see FIG. 2)

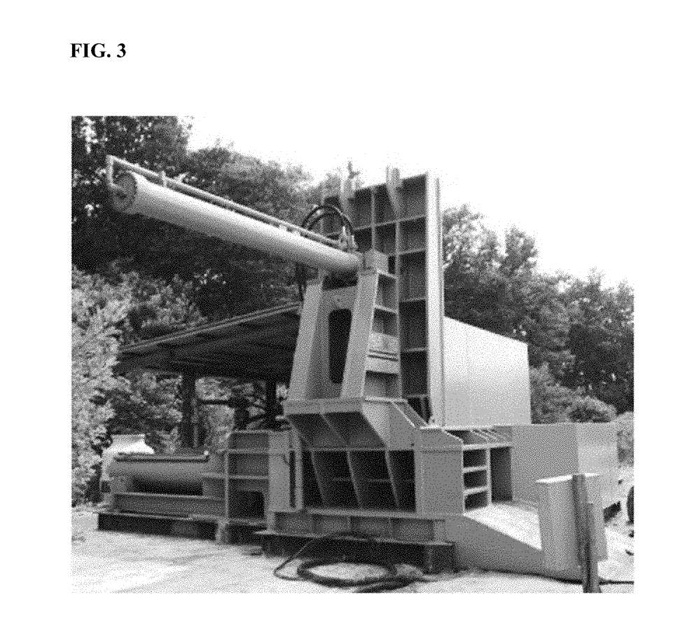

A third resource is a scrap metal pressing facility being a large iron structure facility. (see FIG. 3 (Ltd.) Geongwon E&G internet site [http://www.gweng.co.kr/gweng/product02.php] 2015 Jun. 9)

A fourth resource is a yard for stacking compressed scrap metals and large scraps for waiting supply and a crane for measuring carrying capacity.

A fifth resource is working persons to inspect a scrap metal for giving a grade thereto before supply.

Each businessman for collecting and processing scraps and running a supplier substantially needs the above essential resources. The above resources are rarely simultaneously used, and an idle period occurs at a time difference.

Accordingly, each businessman commonly prepares the above resources and pays a great fixed cost to manage maintenance of the resources. However, a used frequency of the resources is low so that profitability is significantly deteriorated.

Further, since businessmen of a small scale supplies a small amount of scrap metals, supply quantity is small so that a steel manufacturer collects and inputs the supply quantity several times into a furnace so that it is difficult to properly pay the supply cost due to increase of keep and management.

### DISCLOSURE

### Technical Problem

An embodiment of the present invention provides a profit generation method by means of a building team using idle resources associated with occurrence of scraps capable of generating a profit by reducing a fixed cost related to various resources of small scale businessmen and applying a favorable supply cost from a steel manufacturer by collecting supply quantities to increase the supply quantity by supplying a scrap by a building team configured for a limited time for performing the whole process from the occurrence of the scrap to supply to a steel manufacturer using inevitably occurrence idle resources such as various types of excavators and cargo trucks [tongued cargo truck (referred to as ‘hybrid car’)], scrap compression devices, yards, inspection grade determining persons of most small scale businessmen collecting and processing scraps and running the supply.

### Technical Solution

In order to accomplish the above objective, in the present invention, a plurality of businessmen including various resources such as an excavator, a cargo truck, a scrap metal pressing facility, a yard, and a grad determining person transmits information such as an idle start date, an expected idle end date, types, sizes, positions, quantities of corresponding resources inevitably generated to a web server in wired and wireless schemes. The web server combines the resources by times and places according to scrap supply information and scrap occurrence information to perform a building team operation for supplying one scrap, and transmits data such as a field reach time, a moving position and an operation time of a corresponding resource to respective businessmen including the resources.

Accordingly, each businessman moves a corresponding resource to a corresponding position at a field reach time to perform a granted operation, and transmits a performing finish data after operation finish to the web server in wired and wireless schemes. As a result, the present invention may sequentially rearrange available resources to perform a building team for performing the whole process from the occurrence of scraps to supply thereof in a series of steps including a primary processing and boarding to the traffic vehicle and movement and unload to the compressed scrap metal facility, boarding of the processed compressed scrap metal and measuring a weight thereof, unload or stack on a yard for supplying the scraps after moving to the steel manufacturer in a scrap collection field processing step using resources in an idle state for a limited time as listed upon the occurrence of scraps such as the occurrence of scraps due to demolition of building or various facilities or scrap vehicles.

### Advantageous Effects

As described above, the present invention may additionally generate a profit by processing and supplying the generated scraps using only idle resources of small scale businessmen without paying facility and maintenance costs such as facility costs or labor costs as fixed cost, so that the small scale businessmen may share the profit by distributing the profit. When a plurality of scrap processing quantities according to the present invention are collected in a region unit of or in a national unit, since the quantity is sufficient, a large amount may be supplied and a worker may receive a reasonable supply cost in a favorable condition from a steel manufacturer.

### DETAILED DESCRIPTION OF THE DISCLOSURE

FIG. 1 is a photo illustrating an excavator according the related art.

FIG. 2 is a photo illustrating a cargo truck according to the related art.

FIG. 3 is a photo illustrating a compressed scrap metal facility according to the related art.

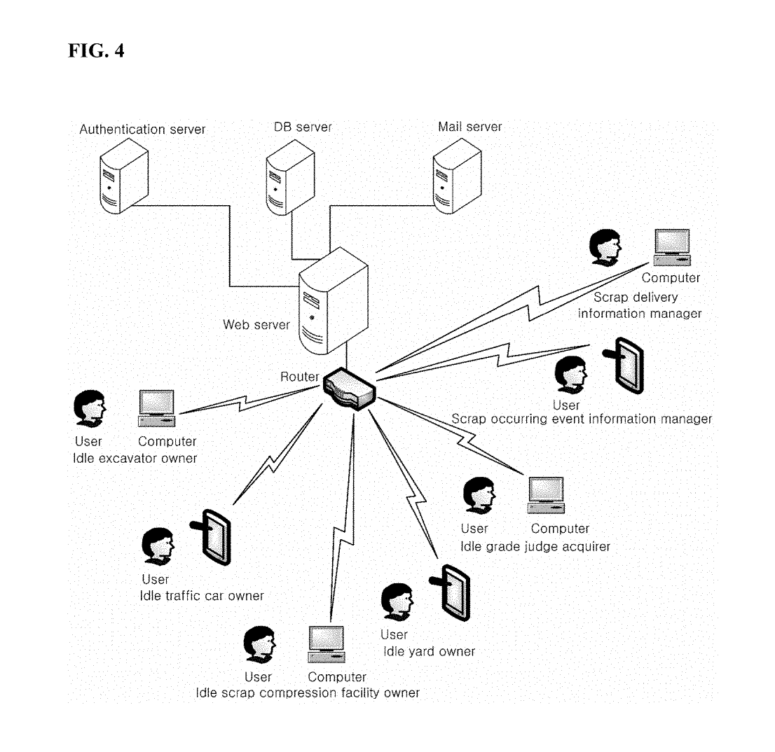

FIG. 4 is a diagram illustrating a hardware system according to the present invention.

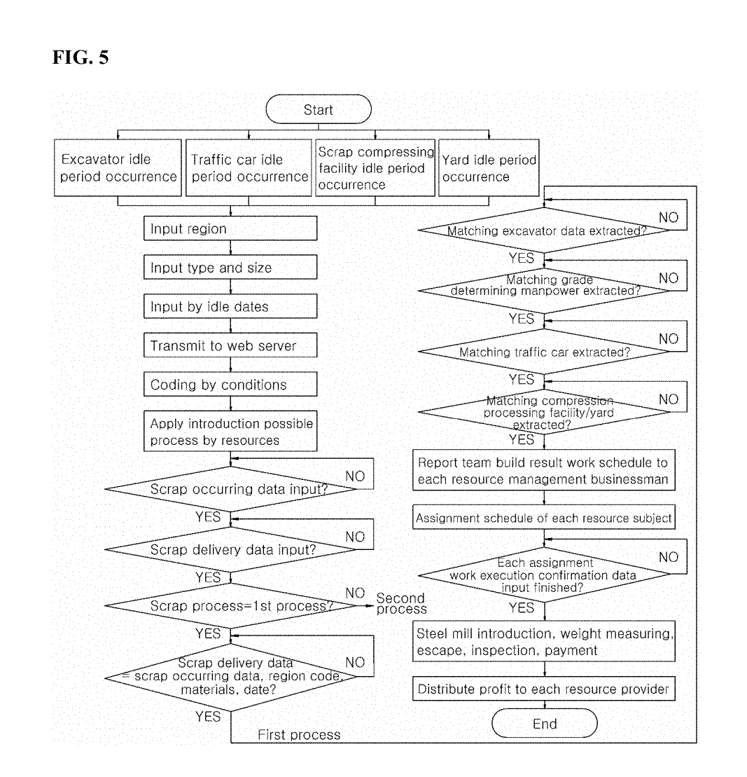

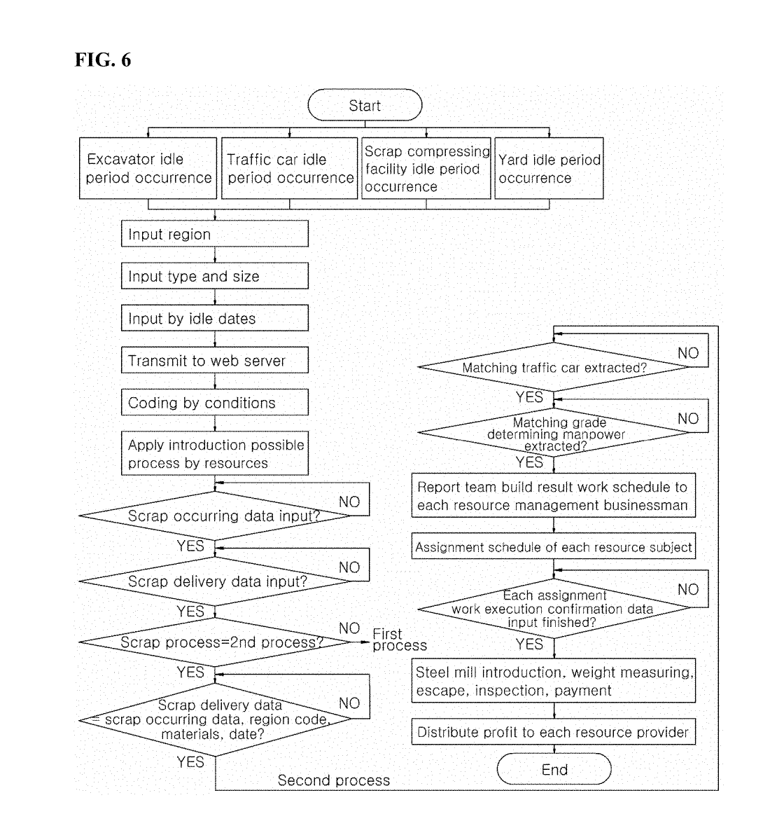

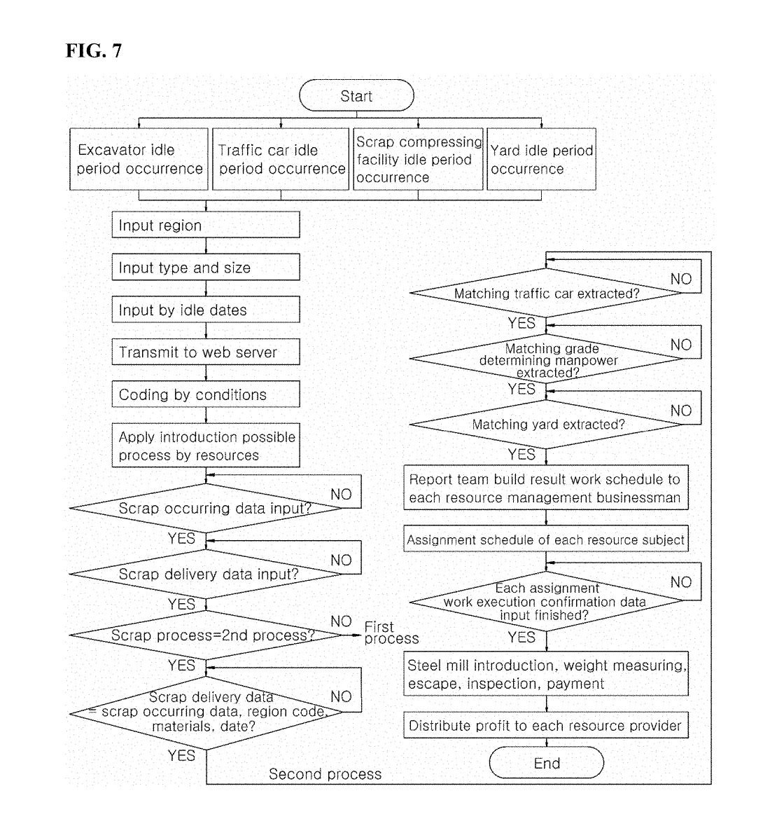

FIG. 5, FIG. 6, and FIG. 7 are flowcharts illustrating an embodiment of the present invention.

### BEST MODE

A profit generation method by means of a building team using idle resources associated with occurrence of scraps, includes: connecting with a web server when an idle state of resourced involved by businessmen occurs to transmit resource data including types, sizes, quantities, an idle start date, an expected idle finish data of the resources, an area of a corresponding resource, an address and e-mail address information of a resource involving company to a web server according to a form provided from the web server by a terminal;

repeating storage of the received resource data in a database server after checking an error for the received resource data by the web server;

inputting scrap occurrence information to the web server by an information manager terminal when the scraps occur;

inputting scrap supply information including materials, a steel manufacturer warehouse data and an address of a warehouse place of the steel manufacturer by a scrap supply information manager terminal;

fetching the materials and the steel manufacturer warehouse date included in the scrap supply information from the database server by the web server after inputting the resource data, scrap occurrence data, and scrap supply data by a businessman terminal;

searching the scrap occurrence information from the database server to determine whether scrap occurrence data sufficient to satisfy the materials and the steel manufacturer warehouse date included in the scrap supply date are included in the scrap occurrence information;

sequentially listing resources capable of performing steps including collection, processing, and transportation for supplying the scraps when the scrap occurrence data sufficient to satisfy the materials and the steel manufacturer warehouse date included in the scrap supply date are included in the scrap occurrence information;

fetching the resource data from the database server to determine whether excavator matching data being one of idle period resources is included in the resource data;

instructing warehouse of a corresponding excavator into a field by the web server when a position of resource data on an excavator corresponds to position data included in the scrap occurrence data;

fetching data from the database server for introducing a personnel for grade assessment, and comparing occurrence date data of the scrap occurrence data with idle period data of the personnel for grade assessment when a region code included in the scrap occurrence data corresponding to the fetched data to instruct dispatch of a corresponding personnel for grade assessment when the occurrence date data of the scrap occurrence data correspond to the idle period data of the personnel for grade assessment by the web server;

fetching the data from the database server for performing a transportation process by a cargo truck being a resource to instruct warehouse of a corresponding cargo truck by the web server when a region code of the cargo truck being the resource corresponds to a region code of the scrap occurrence data and a scrap metal occurrence date is within an idle period of the cargo truck;

fetching the resource data from the database server to instruct warehouse of a corresponding scrap metal pressing facility by the web server when a region code of a scrap pressing facility corresponds to the region code of the scrap occurrence data and the scrap metal occurrence date is within an idle period of a scrap metal pressing facility; and

fetching the data from the database server for performing a transportation process to a steel manufacturer by the cargo truck being the resource to instruct warehouse of a corresponding cargo truck by the web server when a region code of the cargo truck being the resource corresponds to the region code of the scrap occurrence data and the scrap metal occurrence date is within an idle period of the cargo truck being the resource so that the scraps are transported to the steel manufacturer.

Hereinafter, the embodiments will be described with reference to accompanying drawings in detail so that those skilled in the art to which the invention pertains can easily realize the embodiments.

FIG. 4 illustrates an example of a hardware system according to the present invention for performing a method of creating a profit by a building team using an idle period resource upon the occurrence of scrap. FIG. 5 and FIG. 6 are flowcharts illustrating a profit generation method according to an exemplary embodiment. The present invention will be described by steps as follows.

The present invention sequentially performs the steps of: connecting with a web server when an idle state of resourced involved by a plurality of small businessmen occurs to transmit resource data including types, sizes, quantities, an idle start date, an expected idle finish data of the resources, an area of a corresponding resource, an address and e-mail address information of a resource involving company to a web server according to a form provided from the web server by a terminal (a computer and the like);

repeating storage of the received resource data in a database server after checking an error for the received resource data by the web server;

inputting scrap occurrence information to the web server by an information manager terminal when the scraps occur;

inputting scrap supply information including materials, a steel manufacturer warehouse data and an address of a warehouse place of the steel manufacturer by a scrap supply information manager terminal;

fetching the materials and the steel manufacturer warehouse date included in the scrap supply information from the database server by the web server after inputting the resource data, scrap occurrence data, and scrap supply data by a businessman terminal; searching the scrap occurrence information from the database server to determine whether scrap occurrence data sufficient to satisfy the materials and the steel manufacturer warehouse date included in the scrap supply date are included in the scrap occurrence information;

sequentially listing resources capable of performing steps including collection, processing, and transportation for supplying the scraps when the scrap occurrence data sufficient to satisfy the materials and the steel manufacturer warehouse date included in the scrap supply date are included in the scrap occurrence information;

fetching the resource data from the database server to determine whether excavator matching data being one of idle period resources is included in the resource data;

instructing warehouse of a corresponding excavator into a field by the web server when a position of resource data on an excavator corresponds to position data included in the scrap occurrence data;

fetching data from the database server for introducing a personnel for grade assessment, and comparing occurrence date data of the scrap occurrence data with idle period data of the personnel for grade assessment when a region code included in the scrap occurrence data corresponding to the fetched data to instruct dispatch of a corresponding personnel for grade assessment when the occurrence date data of the scrap occurrence data corresponds to the idle period data of the personnel for grade assessment by the web server;

fetching the data from the database server for performing a transportation process by a cargo truck being a resource to instruct warehouse of a corresponding cargo truck by the web server when a region code of the cargo truck being the resource corresponds to a region code of the scrap occurrence data and a scrap metal occurrence date is within an idle period of the cargo truck;

fetching the resource data from the database server to instruct warehouse of a corresponding scrap metal pressing facility by the web server when a region code of a scrap pressing facility corresponds to the region code of the scrap occurrence data and the scrap metal occurrence date is within an idle period of a scrap metal pressing facility; and

fetching the data from the database server for performing a transportation process to a steel manufacturer by the cargo truck being the resource to instruct warehouse of a corresponding cargo truck by the web server when a region code of the cargo truck being the resource corresponds to the region code of the scrap occurrence data and the scrap metal occurrence date is within an idle period of the cargo truck being the resource so that the scraps are transported to the steel manufacturer.

The present invention may selectively include instructing warehouse of a corresponding yard by the web server when the region code of the scrap occurrence data corresponds to a region code of a yard being a resource and the scrap metal occurrence date is within an idle period of the yard between the instructing of the warehouse of a corresponding scrap metal pressing facility and the instructing of the warehouse of a corresponding cargo truck so that the scraps are transported to the steel manufacturer.

An exemplary embodiment of the present invention will be described in detail.

The present invention combines the resources by times and places according to scrap occurrence information to perform a team build operation for supplying one scrap, and transmits data such as a field reach time, a moving position and an operation time of a corresponding resource to respective businessmen involving the resources.

Accordingly, each businessman moves a corresponding resource to a corresponding position at a field reach time to perform a granted operation, and transmits a performing finish data after operation finish to the web server in wired and wireless schemes.

As a result, the present invention may sequentially and spatially rearrange available resources to perform a building team for performing the whole process from the occurrence of scrap to supply thereof in a series of processes including a primary processing and boarding to the cargo truck and movement and unload from the compressed scrap metal facility, carriage of the processed compressed scrap metal and measuring a weight thereof, unload or stack on a yard for supplying the scraps after moving to the steel manufacturer in a scrap collection field processing step using resources in an idle state for a limited time as listed upon the occurrence of scraps such as the occurrence of scraps due to demolition of building or various facilities or scrap vehicles.

To this end, since a plurality of small scale businessmen including various types of excavators and cargo trucks [tongued cargo truck (referred to as ‘hybrid car’), scrap compression devices, yards, inspection grade determining persons have a difficulty in simultaneously using the resources, the present invention connects with a web server as shown in FIG. 4 using terminals such as a PC, a smart phone, and a notebook computer storing relation data upon an idle state of inevitably occurrence resources, and transmits a type, a size, and a quantity of a resource, an idle start date, an expected idle finish date, an area in which a corresponding resource is located, an address and an e-mail address of a resource owner, and finance information such as an account number for deposit to the web server in wired and wireless schemes according to a form provided from the web server.

Accordingly, the web server determines whether an error is included in received resource data to repeatedly store the resource data in a suitable data form such as a structure form.

Next, the web server applies a code to resource data stored in a database by input possible steps.

For example, in relation to a type and a size of a resource, a code 0100, a code 0225, and a code 0205 are applied to an excavator, a cargo truck having a loading weight of 25 tons, and a hybrid car having a loading weight of 5 tons, respectively. A code 0300, a code 0400, and a code 0500 are applied to a compressed scrap facility, a yard, and a grade determining person, respectively. In relation to the size, an area unit code 01, an area unit code 02, an area unit code 03, and an area unit code 04 are applied to Seoul, South Gyeonggi-do, North Gyeonggi-do, and Chungcheongnam-do, respectively. An idle start date code, an idle finish date code, and year, month, and date of the idle period are expressed by 0, 1, and 150610, respectively.

For example, data expressed by the web server and stored in the database may be as follows.

Example 1: “01000201506101150625”

Example 2: “02250201506101150625”

Example 3: “02050201506101150625”

Example 4: “03000201506101150625”

Example 5: “04000201506101150625”

Example 6: “05000201506101150625”

The example 1 is data indicating an idle period from Jun. 10, 2015 (0150610) to Jun. 25, 2015 (1150625) in a south Gyeonggi-do (02) by an excavator (0100).

The example 2 is data indicating an idle period from Jun. 10, 2015 (0150610) to Jun. 25, 2015 (1150625) in a south Gyeonggi-do (02) by a cargo truck (0225).

The example 3 is data indicating an idle period from Jun. 10, 2015 (0150610) to Jun. 25, 2015 (1150625) in a south Gyeonggi-do (02) by a hybrid car of 5 tons (0205).

Further, the example 4 is data indicating an idle period from Jun. 10, 2015 (0150610) to Jun. 25, 2015 (1150625) in a south Gyeonggi-do (02) by a compressed scrap facility (0300).

In addition, the example 5 is data indicating an idle period from Jun. 10, 2015 (0150610) to Jun. 25, 2015 (1150625) in a south Gyeonggi-do (02) by a yard (0400).

Finally, the example 6 is data indicating an idle period from Jun. 10, 2015 (0150610) to Jun. 25, 2015 (1150625) in a south Gyeonggi-do (02) by a grade determining person (0500).

When the examples are processed as data, the data are converted into a HEXA code to be programmed so that the HEXA code may be easily for data processing such as comparison.

In order to prevent failure during transmission of data, a known PARITY CHECK CODE may be added to a rear end of the data to be used.

As described above, the created resource data are repeatedly input by a plurality of small scale businessmen and are stacked in a database server.

Further, in the present invention, a condition in which occurrence scraps may be supplied and accordingly a following process is performed at an occurrence time of scraps. That is, in the present invention, income scrap metals occur according to an income schedule. Prompt Industrial Scrap metals continuously occur during a procedure of manufacturing various products using iron materials in a machine factory, an iron material processing plant, a shipyard, and a vehicle factory. Obsolescent Scrap metals occur to fill a fixed period from scrap vehicles, fixtures, railway rails, machine molds, abandoned ships, waste reinforced materials, and steel structures occurring from a building demolition construction.

When the income scrap metals, Prompt Industrial Scrap metals, and Obsolescent Scrap metals occur, a scrap occurrence information manager receiving external information inputs data such as scrap metal growth codes, scrap metal occurrence time, quantity, positions, and materials obtained by separately inputting codes in a case of a general scrap metal and codes in a case where a scrap metal is a massive scrap metal such as mold. According to growth codes, any one of scrap process selection steps configured in FIG. 5 or FIG. 6 is performed.

That is, in the present invention, a growth code 0 represents a general scrap metal, and a growth code 1 represents a massive scrap metal. Materials are classified into 01: irons, 02: coppers, 03: alumina, and 04: stainless steels. The materials include scrap occurrence date data. Similar to the resource data, an area unit code 01, an area unit code 02, an area unit code 03, and an area unit code 04 are applied to Seoul, South Gyeonggi-do, North Gyeonggi-do, and Chungcheongnam-do, respectively.

Accordingly, an example 7 represents a code to which a scrap occurrence information manager inputs.

Example 7: 00115061002

The example 7 indicates that a general scrap metal 0 occurs, a material is an iron (01), an occurrence time is Jun. 10, 2015 (150610), and a position is South Gyeonggi-do (02).

The scrap occurrence manager stacks scrap occurrence information in a database server by inputting the scrap occurrence information every scrap occurrence event.

Further, the scrap occurrence information may be stored together with additional information such as an address of a scrap occurrence place and a manager e-mail of the scrap occurrence place in a structure form.

In this state, the scrap supply information manager inputs scrap supply information such as materials, a warehouse date of a steel manufacturer and an address of a warehouse place in the steel manufacturer. For example, the material classification code may be determined as 01: irons, 02: coppers, 03: alumina, and 04: stainless steels.

Furthermore, a warehouse date of the steel manufacturer uses expression of year, month, and date. An address of the warehouse place may be coded and expressed as 01: Dangjin, 02: Ulsan, and 03: Pohang.

The data may be a form as illustrated in the example 8.

Example 8: “0115061001”

As described above, when all of a plurality of resource data (example 1 to example 6 and scrap occurrence data (example 7), and scrap supply data (example 8) are input by a plurality of small scale businessmen, since a resource provider, a scrap metal occurrence source and a warehouse request of a steel manufacturer are all included, the web server starts a substantial building team. To this end, firstly, the web server fetches scrap supply data from a database server to fetch materials included in the scrap supply information and steel manufacturer warehouse date data.

Next, the web server searches the scrap occurrence information from the database server to determine whether scrap occurrence data capable of satisfying materials and a steel manufacturer warehouse date included in scrap supply data are included in the searched scrap occurrence information.

To this end, the present invention fetches a material classification code 01 and year/month/date indication 150610 to determine whether a material classification code 01 is included in the scrap occurrence data. When the material classification code 01 is included in the scrap occurrence data, the present invention collects scraps of an occurrence source to input corresponding scrap occurrence information data if year/month/date data of the scrap occurrence data are smaller than or equal to year/month/date of the scrap supply data.

To this end, when the year/month/date data of the scrap occurrence data are smaller than or equal to year/month/date of the scrap supply data, the present invention determines by a following <Comparison equation 1>.

150625(scrap occurrence date of scrap occurrence data)≤15062×(steel manufacturer warehouse date of scrap supply data) <Comparison equation 1>

As described above, scraps to be collected are determined. Next, the web server performs a series of processes for the building team.

That is, the present invention sequentially lists resources to perform a plurality of steps such as collection, processing, and transportation for supplying scraps, and takes action necessary for each step. To this end, the web server firstly fetches a growth code of the scrap occurrence data in order to select a scrap metal process. Since the growth code is 0 as illustrated in the example 7 and is a general scrap metal, the web server performs a process of manufacturing a general compression molding scrap.

To this end, the present invention performs a first process shown in FIG. 5. To this end, as shown in FIG. 5, the web server firstly fetches resource data from a database server to determine whether excavator matching data in an idle period is are included in the fetched resource data. To this end, the web server compares a scrap occurrence date of the scrap occurrence data with idle start date data of an excavator as illustrated in the example 1 to determine whether a relationship as illustrated is <Comparison equation 2> is established.

150610(scrap occurrence date of scrap occurrence data)≥15061×(idle start date of excavator) <Comparison equation 2>

When a condition of the example <Comparison equation 2> is satisfied, the web server determines whether position data as illustrated in the example 7 corresponds to a position code of resource data. When the position data as illustrated in the example 7 corresponds to a position code of resource data, since a corresponding excavator may provide an idle period from an occurrence date of the scrap metal to a processing finish time, the excavator is introduced so that a field operation and processing are possible. Next, as shown in FIG. 5, the web server fetches data as illustrated in the example 7 from the database server in order to perform a grade determining step and a manpower warehouse step. When a region code corresponds thereto, the web server compares occurrence date data of scrap occurrence data with idle period data of a personnel for grade assessment. As illustrated in <Comparison equation 3>, since a scrap occurrence date (Jun. 10, 2015) is present from Jun. 10, 2015 to Jun. 25, 2015 which is an idle period of a personnel for grade assessment, the personnel for grade assessment becomes a target resource. When the region code or an idle period does not correspond thereto, the personnel for grade assessment cannot become a target resource.

150610(start date of idle period)≤150610(scrap occurrence date)≤150625(end date of idle period) <Comparison equation 3>

As described above, after ensuring the personnel for grade assessment, as shown in FIG. 5, the web server fetches data as illustrated in the example 2 from the database server in order to perform a transportation process by a cargo truck.

Example 2: “02250201506101150625”

Since the above data indicate that a cargo truck of 25 tons (0250) has an idle period from Jun. 10, 2015 to Jun. 25, 2015 at south Gyeonggi-do (02), an area code (02) of resource data corresponds to the scrap occurrence data. As illustrated in the Comparison equation 3, since the scrap metal occurrence date is within an idle period of a cargo truck, the cargo truck becomes an available target resource.

Further, as shown in FIG. 5, the web server fetches resource data from the database server in order to perform a processing step by a scrap pressing facility. For example, since the web server fetches data as illustrated in the example 3, the data are south Gyeonggi-do (02) where an area code of the compressed scrap facility (0300) corresponds to an area code of the scrap occurrence data. As illustrated in the comparison equation 3, since the scrap metal occurrence date is within an idle period of the scrap metal pressing facility, the scrap metal pressing facility becomes an available target resource.

Further, in the present invention, as shown in FIG. 5, since it may be necessary to stack a processed compressed scrap metal, the web server fetches data as illustrated in the example 4 from the database server for ensuring a yard so that it is assumed to currently require a yard and a region code of the scrap occurrence data are the same as a region code of the yard being a resource. As illustrated in the comparison equation 3, since the scrap metal occurrence date is within an idle period of a yard, the scrap metal pressing facility becomes an available target resource.

In addition, working may be delayed for several days than a scrap metal occurrence date due to large quantity or reason of a scrap metal pressing facility in reality. However, it is preferred that an idle period of a yard is programmed to satisfy a following <Comparison equation 4> by taking into consideration the above case.

Idle period start date of yard≤scrap occurrence date≤idle period finish date &

idle period start date of yard≤scrap occurrence date+X≤idle period finish date <Comparison equation 4>

The resources ensured by the above procedure includes an excavator, an inspection personnel for grade assessment, a cargo truck, a scrap pressing facility, and a yard, and are sequentially arranged in a standard scrap metal processing step, and may be changed according to a quantity or a condition of a work place. If it is assumed that there is a need for two days working, resources are arranged in a working order as illustrated in a following <Table 1>

TABLE 1

| | | | | | Pressing |
|---|---|---|---|---|---|
| | | | | Demining | facility |
| Schedule | | Excavator | Cargo truck | manpower | company |
| First | Morning | Field | | Inspection | |
| day | | processing | | grade | |
| | | work | | determi- | |
| | | | | nation | |
| | Afternoon | Field | (Field ↔ | | Perform |
| | | processing | pressing | | Processing |
| | | work | facility) | | step |
| Second | Morning | Field | | | Perform |
| day | | processing | | | Processing |
| | | work | | | step |
| | Afternoon | | (Pressing | | |
| | | | facility ↔ | | |
| | | | steel | | |
| | | | manufacturer) | | |

Accordingly, in a case of <Table 1>, a mail server transmits a first day morning designation time and a scrap occurrence place address in a company involving an idle excavator. An idle cargo truck involving company transmits a first day afternoon designation time, a scrap occurrence place address, a pressing facility company address, a second day afternoon designation time, and a steel manufacturer address. Moreover, the mail server transmits a first day morning designation time and a scrap occurrence place address to a personnel for grade assessment company, and transmits a scrap metal warehouse time by a cargo truck in a first day afternoon and a boarding time of a second day afternoon to a cargo truck to a scrap metal pressing facility company that allows the personnel for grade assessment company and the compressed scrap metal facility company to perform an internal preparation for performing a processing procedure.

Accordingly, the idle resource involving company sequentially dispatches the resources or prepares a working. The web server sequentially receives a performing finish situation of respective steps.

In detail, a terminal of a company involving an idle excavator transmits work start data and a first day morning working finish data to the web server at a designation time of the first day.

Next, a terminal of an idle cargo truck company transmits a first day afternoon scrap metal boarding finish and compressed facility company unload finish data and second day afternoon compressed scrap metal boarding time data and steel manufacturer warehouse time data to the web server.

The personnel for grade assessment transmits inspection grade determining data using a terminal thereof.

A terminal of the pressing facility company transmits processing start time data and processing finish data to the web server.

After all the data are transmitted, weight measuring unload inspection supply confirmation data are transmitted and all procedure finish is recognized. After a distributed offline profit is transmitted or a distributed online profit is transmitted through an authentication server, an operation for a money input from a steel manufacturer finishes.

In the present invention, when a profit of a money received from the steel manufacturer is distributed, a ratio thereof may be determined based on a level received by providing a general resource from the field or may be implemented as a contact by a free will between parties. A technology of a concrete example thereof is omitted for convenience.

The above embodiment of the present invention has described on the assumption that supply is implemented to a steel manufacturer by a cargo truck immediately upon completion of a processing step by the scrap metal pressing facility. However, there may be a need to stack the processed compressed scrap metals due to circumferences of a steel manufacturer in reality.

Further, in this case, it is most preferred to stack scraps in a yard of a corresponding compressed scrap metal facility so that it is unnecessary to inconveniently board and unload the cargo truck. It is necessary to stack the scraps after moving to a yard of another location. In this case, boarding on the cargo truck, moving to a yard, unload from the yard, boarding on the cargo truck and moving to the cargo truck upon the supply to the steel manufacturer, and introducing to the steel manufacturer are performed. In this case, a terminal of an idle cargo truck company and a terminal of a yard company should transmit data to the web serve. For example, in the present invention, if it is assumed that two days are worked and one day stack is performed according to a situation of a work place, resources may be arranged in a work order as illustrated in a following <Table 2>.

TABLE 2

| | | | | | Pressing |
|---|---|---|---|---|---|
| | | | | Determining | facility |
| Schedule | | Excavator | Cargo truck | person | company |
| First | Morning | Field | | Inspection | |
| day | | processing | | grade | |
| | | work | | determi- | |
| | | | | nation | |
| | Afternoon | Field | (Field | | Perform |
| | | processing | board ↔ | | processing |
| | | work | pressing | | step |
| | | | facility | | |
| | | | unload) | | |
| Second | Morning | Field | | | Perform |
| day | | processing | | | processing |
| | | work | | | step |
| | Afternoon | | (Pressing | | |
| | | | facility | | |
| | | | board ↔ | | |
| | | | yard unload) | | |
| Third | Morning | | | | |
| day | Afternoon | | (Yard | | |
| | | | board ↔ | | |
| | | | steel | | |
| | | | manufacturer | | |
| | | | warehouse) | | |

In this case, in the present invention, detailed procedures including a work finish report in each resource involving company and a profit distribution by a web server are omitted.

Further, in the present invention, as in the embodiment as illustrated in FIG. 5, small scale businessmen involving resources transmits resource data thereof, receives scrap occurrence data from a scrap occurrence source or inputs the scrap occurrence data ensured by a sales network thereof. Next, if scrap supply data of a steel manufacturer are input, when a scrap occurring using scrap occurrence data by the web server is a massive scrap metal instead of a general scrap metal, the scrap occurrence data are stored in the database server in the form as illustrated in a following example 9.

Example 9: 10115061002

Accordingly, the web server recognizes according to the above data that a massive scrap metal (1) occurs, a material is an iron (01), an occurrence date is Jun. 10, 2015 (150610) and a location is South Gyeonggi-do (02).

In some cases, since the massive scrap metal is collected from a field and is boarded on a vehicle, it is preferred that a massive scrap is collected and boarded by a cargo truck (hybrid car) rather than an excavator.

To this end, as shown in FIG. 6, the web server firstly fetches resource data from the database server to determine whether hybrid car data having 5 tons in an idle period are included in the resource data. In this case, as illustrated in the example 3, the web server searches data having a code of 0205.

Furthermore, the embodiment fetches data from the database in order to perform a personnel for grade assessment input step before boarding a massive scrap metal on a hybrid car. Since there is need for personnel for grade assessment data at the present time, the web server fetches data as illustrated in the example 8 afterwards.

Example 8: “05000201506101150625”

Such data indicate that a personnel for grade assessment (0500) has an idle period from Jun. 10, 2015 to Jun. 25, 2015 in a South Gyeonggi-do (02). When the scrap metal occurrence date is Jun. 10, 2015, the personnel for grade assessment is a target resource.

In addition, in the present invention, as shown in FIG. 7, since it may be a need to stack processed compressed scrap metals, the web server fetches data as illustrated in the example 1 from the database server in order to ensure a yard. Since there is a need for a yard at the present time, the fetches data as illustrated in the example 5 later.

Example 5: “04000201506101150625”

Since the above data indicate that a yard (0300) capable of stacking a compressed scrap metal has an idle period from Jun. 10, 2015 to Jun. 25, 2015 in a South Gyeonggi-do (02). As described above, when the scrap metal occurrence date is Jun. 10, 2015, the yard may be an available target resource.

Resources ensured by such a procedure includes a hybrid car and an inspection grade determining person. In this case, the resources are sequentially arranged in a standard scrap metal processing step, and a schedule is adjusted by weighting according to the quantity.

As described above, in some cases where a massive scrap metal is one day quantity, the resources are arranged as illustrated in a following Table 3 in a work order as illustrated in a following table.

TABLE 3

| | | |
|---|---|---|
| Schedule | Hybrid car | Demining person |

| | | | |
|---|---|---|---|
| First | Morning | Field collection | Inspection grade |
| day | | | determination |
| | Afternoon | (Pressing facility ↔ | |
| | | steel manufacturer) | |

Accordingly, a mail server transmits a working schedule, a scrap occurrence place, and an address of a steel manufacturer or a yard to a company including a hybrid car, and transmits a morning designation time and a scrap occurrence place address to a determining person. Accordingly, the resource is sequentially dispatched to an idle resource involving company. The web server receives a performing finish situation of each step. In detail, a terminal of a company involving a hybrid car at a first day transmits work field address data, a first day morning and boarding in a first day afternoon field, and unload finish data from a steel manufacturer to the web server. The determining person transmits inspection grade determining data to a web server using a terminal thereof at a first day. After all the data are transmitted, a steel manufacturer finally transmits a weight measuring unload inspection supply confirmation data to the web server so that finishing of all procedures is recognized. A profit of money received from the steel manufacturer is distributed to each resource provider through the authentication server so that all the procedures finish.

In this case, in the present invention, when a profit of a money received from the steel manufacturer is distributed, a ratio thereof may be determined based on a level received by providing a general resource from the field or may be implemented as a contact by a free will between parties.

The above embodiment of the present invention has described on the assumption that supply is implemented to a steel manufacturer by boarding the scrap metal on the hybrid car. However, there may be a need to stack the processed compressed scrap metals due to circumferences of a steel manufacturer in reality. The above case lists in a following Table 4.

TABLE 4

| Schedule | | Hybrid car | Determining person |
|---|---|---|---|
| First | Morning | Field collection | Inspection grade determination |
| day | Afternoon | (Field ↔ yard) | |

Yard stack

| | |
|---|---|
| Supply | (Yard↔ steel |
| date | manufacturer) |

As described above, although the present invention illustrates two types of representative scrap metal processing steps from the occurrence of scrap to warehouse to a steel manufacturer in FIG. 5, FIG. 6, and FIG. 7, the use may be variously changed according to a field situation.

Further, the present invention omits a weight measuring process. Since it is difficult to transport scraps to a necessary place to be used, and the scraps are provided at a metal compressing molding facility company or yard, a fixed facility may be additionally used so that a processing step is omitted.

As described above, the present invention has described a method of creating a profit by a building team using an idle period resource upon the occurrence of straps with reference to the accompanying drawings. The above is for the purpose of illustrating most exemplary embodiment but is not intended to be exhaustive or to limit the invention.

An exemplary embodiment of the present invention is disclosed herein, but the present invention is not limited to the disclosed embodiments, but, on the contrary, is intended to cover various modifications and equivalent arrangements included within the appended claims and the detailed description and the accompanying drawing of the present invention.

1. A profit generation method by means of a building team using idle resources associated with occurrence of scraps, the method comprising:
connecting with a web server when an idle state of resourced involved by businessmen occurs to transmit resource data including types, sizes, quantities, an idle start date, an expected idle finish data of the resources, an area of a corresponding resource, an address and e-mail address information of a resource involving company to a web server according to a form provided from the web server by a terminal;
repeating storage of the received resource data in a database server after checking an error for the received resource data by the web server;
inputting scrap occurrence information to the web server by an information manager terminal when the scraps occur;
inputting scrap supply information including materials, a steel manufacturer warehouse data and an address of a warehouse place of the steel manufacturer by a scrap supply information manager terminal;
fetching the materials and the steel manufacturer warehouse date included in the scrap supply information from the database server by the web server after inputting the resource data, scrap occurrence data, and scrap supply data by a businessman terminal;
searching the scrap occurrence information from the database server to determine whether scrap occurrence data sufficient to satisfy the materials and the steel manufacturer warehouse date included in the scrap supply date are included in the scrap occurrence information;
sequentially listing resources capable of performing steps including collection, processing, and transportation for supplying the scraps when the scrap occurrence data sufficient to satisfy the materials and the steel manufacturer warehouse date included in the scrap supply date are included in the scrap occurrence information;
fetching the resource data from the database server to determine whether excavator matching data being one of idle period resources is included in the resource data;
instructing warehouse of a corresponding excavator into a field by the web server when a position of resource data on an excavator corresponds to position data included in the scrap occurrence data;
fetching data from the database server for introducing a personnel for grade assessment, and comparing occurrence date data of the scrap occurrence data with idle period data of the personnel for grade assessment when a region code included in the scrap occurrence data corresponding to the fetched data to instruct dispatch of a corresponding personnel for grade assessment when the occurrence date data of the scrap occurrence data correspond to the idle period data of the personnel for grade assessment by the web server;
fetching the data from the database server for performing a transportation process by a cargo truck being a resource to instruct warehouse of a corresponding cargo truck by the web server when a region code of the cargo truck being the resource corresponds to a region code of the scrap occurrence data and a scrap metal occurrence date is within an idle period of the cargo truck;
fetching the resource data from the database server to instruct warehouse of a corresponding scrap metal pressing facility by the web server when a region code of a scrap pressing facility corresponds to the region code of the scrap occurrence data and the scrap metal occurrence date is within an idle period of a scrap metal pressing facility; and
fetching the data from the database server for performing a transportation process to a steel manufacturer by the cargo truck being the resource to instruct warehouse of a corresponding cargo truck by the web server when a region code of the cargo truck being the resource corresponds to the region code of the scrap occurrence data and the scrap metal occurrence date is within an idle period of the cargo truck being the resource so that the scraps are transported to the steel manufacturer.

2. The method of claim 1, further comprising instructing warehouse of a corresponding yard by the web server when the region code of the scrap occurrence data corresponds to a region code of a yard being a resource and the scrap metal occurrence date is within an idle period of the yard between the instructing of the warehouse of a corresponding scrap metal pressing facility and the instructing of the warehouse of a corresponding cargo truck so that the scraps are transported to the steel manufacturer.

3. The method of claim 1, wherein the resource data stored in the database server comprise the region code and start and finish data of the idle period.

4. The method of claim 1, wherein the scrap occurrence data input to the web server when the scraps occur comprise a growth code, a region code, the scrap metal occurrence date, materials, and quantity data.

5. The method of claim 1, wherein the scrap supply information input to the web server when the scrap supply information is generated comprises materials, a steel manufacturer warehouse date and an address of a steel manufacturer warehouse place.

6. The method of claim 1, wherein a region code and start and finish data of an idle period among the resource data stored in the database server correspond to a region code of the scrap occurrence data and an occurrence data of the scrap occurrence data within an idle period of resources.

7. The method of claim 1, wherein the steel manufacturer warehouse date included in the scrap supply information input to the web server is included in an idle period of the resource data stored in the database server.

8. The method of claim 2, wherein the resource data stored in the database server comprise the region code and start and finish data of the idle period.

9. The method of claim 2, wherein the scrap occurrence data input to the web server when the scraps occur comprise a growth code, a region code, the scrap metal occurrence date, materials, and quantity data.

10. The method of claim 2, wherein the scrap supply information input to the web server when the scrap supply information is generated comprises materials, a steel manufacturer warehouse date and an address of a steel manufacturer warehouse place.

11. The method of claim 2, wherein a region code and start and finish data of an idle period among the resource data stored in the database server correspond to a region code of the scrap occurrence data and an occurrence data of the scrap occurrence data within an idle period of resources.

12. The method of claim 2, wherein the steel manufacturer warehouse date included in the scrap supply information input to the web server is included in an idle period of the resource data stored in the database server.
